(19) United States
(12) Patent Application Publication
(10) Pub. No.: US 2026/0039755 A1
(43) Pub. Date: Feb. 5, 2026

(54) IMAGE FORMING APPARATUS

(71) Applicant: SHARP KABUSHIKI KAISHA, Osaka (JP)

(72) Inventor: KENICHIROH IMAYOSHI, Osaka (JP)

(21) Appl. No.: 19/285,082

(22) Filed: Jul. 30, 2025

(30) Foreign Application Priority Data
Aug. 1, 2024 (JP) 2024-125737

(51) Int. Cl. H04N 1/00

(52) U.S. Cl. CPC H04N 1/00076; H04N 1/0001; H04N 1/00037

(57) ABSTRACT

An image forming apparatus includes a communicator having a plurality of communication ports, and at least one controller that executes a process of determining whether or not each of the communication ports is a target communication port that is open and not in use from an open/closed state and a use history of each communication port included in the plurality of communication ports, and reporting target communication port information indicating the target communication port.

### CROSS-REFERENCE TO RELATED APPLICATION

The present application claims priority from Japanese Application JP2024-125737, filed on Aug. 1, 2024, the content of which is hereby incorporated by reference into this application.

### BACKGROUND

### 1. Field

The present disclosure relates to an image forming apparatus.

### 2. Description of the Related Art

In a conventional technology, there is known an image forming apparatus that includes a timer that monitors time including a calendar function, a display screen with a panel switch function that sets start/end times on a monthly/weekly/daily basis and sets operation of an image forming apparatus main body during the set period on a port-by-port basis, and a port controller that controls the opening and closing of a port set when the time monitored by the timer reaches the set time.

### SUMMARY

In the image forming apparatus known in the conventional technology, a communication port is open when the communication port is available, or the communication port is closed when the communication port is not available. Therefore, in the image forming apparatus known in the conventional technology, the communication port is open even when the communication port is not in use. As a result, unused communication ports become available for communication, and therefore there is a risk that unauthorized access by a malicious user is caused. Therefore, an object of an aspect of the present disclosure is to provide an image forming apparatus that can prevent an unused communication port from being left in an open state.

An image forming apparatus according to an aspect of the present disclosure includes a communicator having a plurality of communication ports, and at least one controller that executes a process of determining whether or not each of the communication ports is a target communication port that is open and not in use from an open/closed state and a use history of each communication port included in the plurality of communication ports, and reporting target communication port information indicating the target communication port.

### BRIEF DESCRIPTION OF THE DRAWINGS

FIG. 1 is a block diagram illustrating an example of a configuration of an image forming apparatus.

FIG. 2 is a diagram illustrating an example of an apparatus use information.

FIG. 3 is a diagram illustrating an example of a communication port use information.

FIG. 4 is a flowchart illustrating an example of operation of the image forming apparatus.

FIG. 5 is a flowchart illustrating an example of operation of the image forming apparatus, which follows FIG. 4.

FIG. 6 is a flowchart illustrating an example of operation of the image forming apparatus, which follows FIG. 5.

FIG. 7 is a diagram illustrating an example of a report screen.

FIG. 8 is a diagram illustrating an example of a setting screen.

FIG. 9 is a diagram illustrating an example of a report screen according to a first modification.

FIG. 10 is a diagram illustrating an example of a confirmation screen.

### DETAILED DESCRIPTION OF THE DISCLOSURE

### First Embodiment

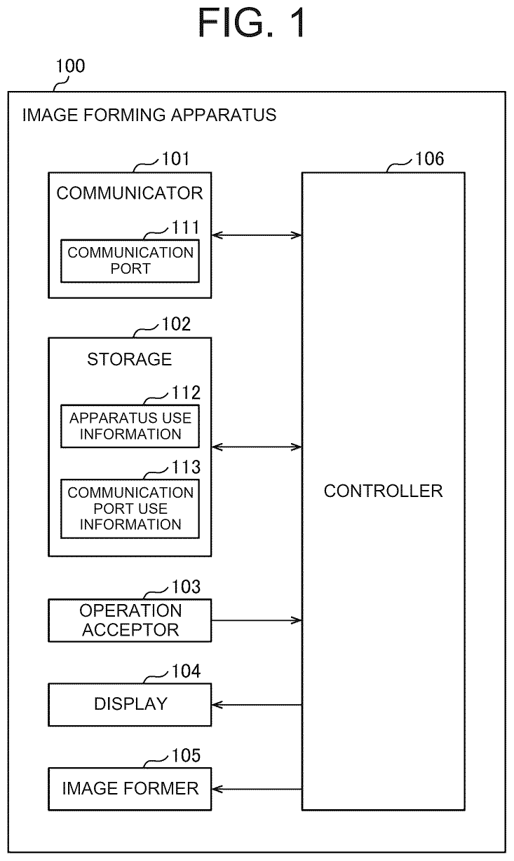

A first embodiment will be described with reference to FIG. 1 to FIG. 8. In the drawings, the same or similar elements are given the same reference numerals, and duplicate description will be omitted.

FIG. 1 is a block diagram illustrating an example of a configuration of an image forming apparatus 100. The image forming apparatus 100 includes a communicator 101, a storage 102, an operation acceptor 103, a display 104, an image former 105, and one or more controllers 106.

The communicator 101 is an interface that connects to the network. The communicator 101 has a plurality of communication ports 111. The communication ports 111 are defined for each protocol on the network.

The communication ports 111 each function as a server port or a client port. In a case where the communication ports 111 function as server ports, the communication ports 111 each establish communication on the basis of on a defined protocol, so that the image forming apparatus 100 receives a signal transmitted from a client apparatus and functions as a server. For example, the client apparatus is a Personal Computer (PC). In a case where the communication ports 111 function as client ports, the communication ports 111 each establish communication on the basis of a defined protocol, so that the image forming apparatus 100 transmits a signal to a server apparatus and functions as a client.

The storage 102 is one or more storage media capable of storing various data, programs, and the like. For example, the storage 102 is composed of one or more Hard Disk Drives (HDDs), one or more Solid State Drives (SSDs), one or more semiconductor memories, or combination of these. The storage 102 stores apparatus use information 112 and communication port use information 113. The apparatus use information 112 indicates a use history of the image forming apparatus 100. The communication port use information 113 indicates a use history of the communication ports 111.

The operation acceptor 103 accepts operation by a user. For example, the operation acceptor 103 is composed of a touch panel, and the like. The display 104 displays information to be presented to the user. For example, the display 104 is composed of a liquid crystal panel, an organic Electro-Luminescence (EL) panel, and the like. A touch panel display in which the operation acceptor 103 and the display 104 are integrated may be constructed.

The image former 105 acquires an image and forms the acquired image on paper. For example, the image former 105 acquires an image transmitted from a client apparatus via the communication port 111 and prints the acquired image on paper.

The controllers 106 each execute various processes according to the programs stored in the storage 102. For example, the controllers 106 each are composed of one or more processors such as a Central Processing Unit (CPU).

The controllers 106 execute a process of determining whether or not each communication port is a target communication port 111 that is open and not in use from an open/closed state and a use history of each communication port included in the plurality of communication ports, and reporting target communication port information indicating the target communication port 111. The use history includes and indicates information indicating a use start date, the total number of days used, and the number of consecutive days of non-use of each communication port 111. The controllers 106 each determine whether or not each communication port 111 is not in use from the use start date, the total number of days used, and the number of consecutive days of non-use of each communication port 111.

In addition, the controllers 106 set whether or not each communication port 111 is opened or closed. Further, the controllers 106 execute a process of prompting the user to close the unused target communication port 111. That is, the controllers 106 execute a process of suggesting to the user to close the communication port 111 that is open and not in use.

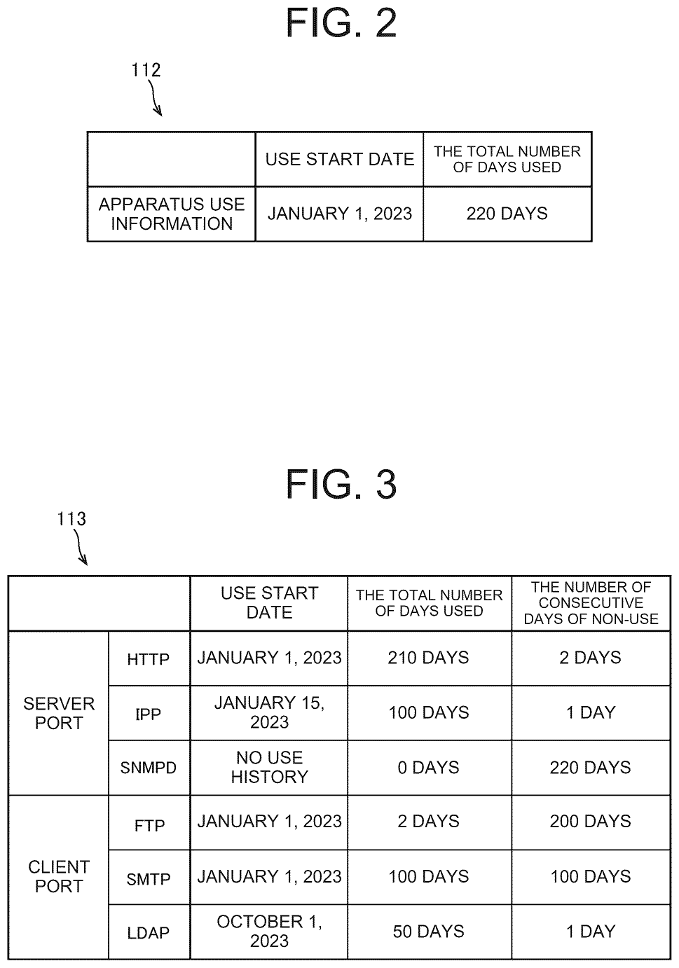

FIG. 2 is a diagram illustrating an example of the apparatus use information 112. The apparatus use information 112 indicates the use start date and the total number of days used, for the image forming apparatus 100. The use start date indicated in the apparatus use information 112 indicates a date on which the image forming apparatus 100 was energized for the first time. The total number of days used indicated in the apparatus use information 112 indicates the total number of days when the image forming apparatus 100 has been energized. In the following description, the apparatus use information 112 illustrated in FIG. 2 indicates the use start date and the total number of days used, for the image forming apparatus 100 as of Dec. 31, 2023. For example, the apparatus use information 112 illustrated in FIG. 2 indicates that the image forming apparatus 100 was energized for the first time on Jan. 1, 2023, and that the total number of days when the image forming apparatus 100 has been energized by Dec. 31, 2023 is 220 days.

FIG. 3 is a diagram illustrating an example of the communication port use information 113. The communication port use information 113 indicates the identification information of each communication port 111 included in the plurality of communication ports 111 by linking the use start date, the total number of days used, and the number of consecutive days of non-use. For example, the identification information for the communication port 111 is the number assigned to each communication port 111. In FIG. 3, for the purpose of description, types of the communication ports are indicated as the identification information of each communication port 111.

The communication port use information 113 illustrated in FIG. 3 indicates the use start date, the total number of days used, and the number of consecutive days of non-use of a Hypertext Transfer Protocol (HTTP), an Internet Printing Protocol (IPP), and a Simple Network Management Protocol Daemon (SNMPD) that function as the server port, and a File Transfer Protocol (FTP), a Simple Mail Transfer Protocol (SMTP), and a Lightweight Directory Access Protocol (LDAP) that function as the client port. In a case where the communication ports 111 are used, the controllers 106 change the number of consecutive days of non-use indicated in the communication port use information 113 to 0 days. In the following description, the communication port use information 113 illustrated in FIG. 3 indicates the use start date, the total number of days used, and the number of consecutive days of non-use of each communication port 111 as of Dec. 31, 2023. For example, the communication port use information 113 illustrated in FIG. 3 indicates that the HTTP communication port received a signal and was used for the first time on Jan. 1, 2023, and the total number of days when the port was used up to Dec. 31, 2023 is 210, and the number of consecutive days of non-use is 2.

For example, the HTTP is used to receive a signal transmitted from the client apparatus by the image forming apparatus 100 and function as a web server. For example, the IPP is used to receive a signal indicating a print instruction transmitted from the client apparatus by the image forming apparatus 100. For example, the SNMPD is used to request information indicating a state of the image forming apparatus from the client apparatus by image forming apparatus 100. For example, the FTP is used to transmit image data to a file server by the image forming apparatus 100. For example, the SMTP is used to transmit an e-mail to an e-mail server by the image forming apparatus 100. For example, the LDAP is used to access an LDAP server to acquire information about a user by the image forming apparatus 100.

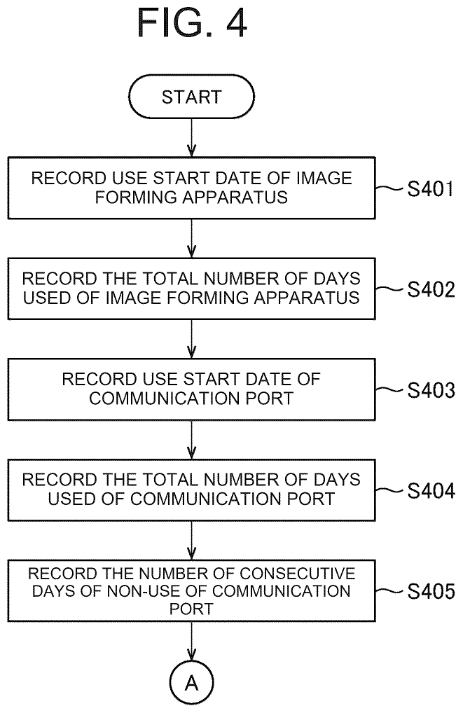

FIG. 4 is a flowchart illustrating an example of operation of the image forming apparatus 100.

In a case where the image forming apparatus 100 is energized for the first time by user's operation, the controller 106 records the use start date of the image forming apparatus 100 in the apparatus use information 112 in Step S401.

In Step S401, after the use start date of the image forming apparatus 100 is recorded in the apparatus use information 112, in a case where the image forming apparatus 100 is used, the controller 106 records the total number of days used in the apparatus use information 112 in Step S402.

In a case where the communication port 111 is used for the first time, the controller 106 records the use start date of the communication port 111 in the communication port use information 113, linking the use start date to the identification information of the communication port 111 in Step S403.

After the use start date of the communication port 111 is recorded in the communication port use information 113 in Step S403, in a case where the communication port 111 is used, the controller 106 records the total number of days used in the communication port use information 113 in Step S404, linking the total number of days used to the identification information of the communication port 111.

In a case where the communication port 111 has not been used for one day or more after the use start date of the communication port 111 is recorded in the communication port use information 113, the controller 106 records the number of consecutive days of non-use in the communication port use information 113, linking the number of consecutive days of non-use to the identification information of the communication port 111, in Step S405.

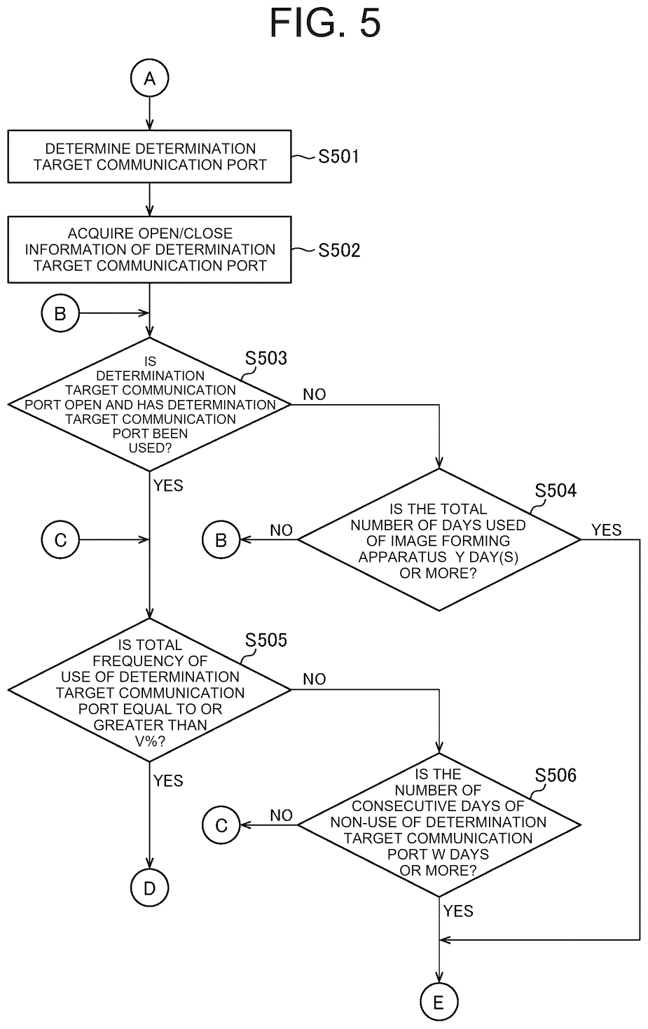

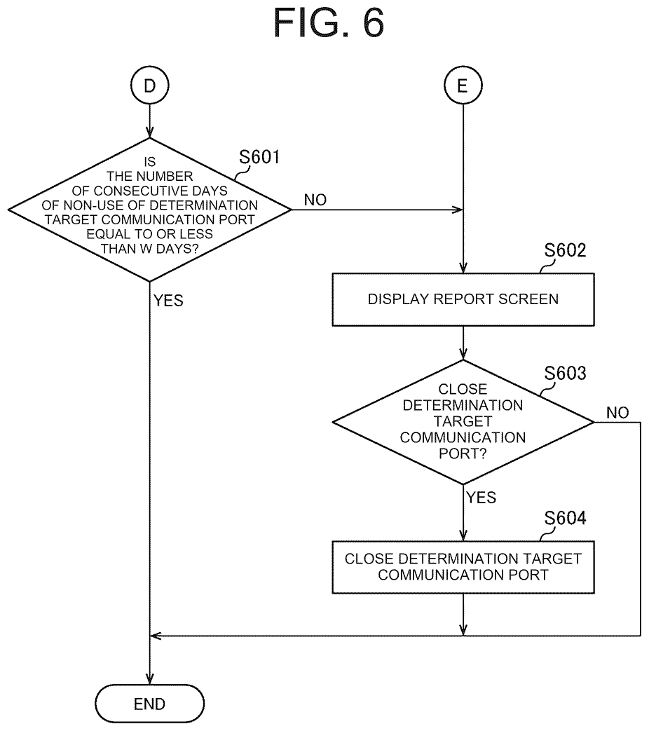

Operation of the image forming apparatus 100 will be further described with reference to FIG. 5 to FIG. 6. FIG. 5 is a flowchart illustrating an example of the operation of the image forming apparatus 100, which follows FIG. 4. It is assumed that the controller 106 executes processes of Step S501 to Step S509 illustrated in FIG. 5 in parallel for each of the plurality of communication ports 111. Furthermore, in the following description, it is assumed that the storage 102 stores the apparatus use information 112 illustrated in FIG. 2 and the communication port use information 113 illustrated in FIG. 3.

In Step S501, the controller 106 determines a determination target communication port 111. For example, the controller 106 determines the determination target communication port 111 from a plurality of the communication ports 111.

In Step S502, the controller 106 acquires open/close information of the determination target communication port 111 determined in Step S501. The open/close information indicates whether or not the communication ports 111 are open. In a case where the communication port 111 is open, this communication port 111 is in a state in which communication is possible. On the other hand, in a case where the communication port 111 is closed, this communication port 111 is in a state in which communication is not possible.

In Step S503, the controller 106 determines whether or not the determination target communication port 111 determined in Step S502 is open and has been used. Specifically, in a case where the open/close information acquired in Step S502 indicates that the communication port is open, the controller 106 determines whether or not the use start date is recorded in the communication port use information 113, linking the use start date to the identification information of the determination target communication port 111. In a case where the communication port use information 113 does not record the use start date linked to the identification information of the determination target communication port 111, the controller 106 determines that the determination target communication port 111 has never been used. In a case where the communication port use information 113 records the use start date linked to the identification information of the determination target communication port 111, the controller 106 determines that the determination target communication port 111 has been used.

In a case where the determination target communication port 111 has not been used in Step S503, the controller 106 determines whether or not the total number of days used of the image forming apparatus 100 is Y day(s) or more, in Step S504. Y day(s) are a predetermined number of days, one or more. Specifically, the controller 106 determines whether or not the total number of days used recorded in the apparatus use information 112 is Y day(s) or more.

In Step S504, in a case where the total number of days used of the image forming apparatus 100 is Y days or more, the controller 106 determines that the determination target communication port 111 is not in used. Then, the controller 106 shifts the process to Step S602 illustrated in FIG. 6. On the other hand, in a case where the total number of days used by the image forming apparatus 100 is less than Y days in Step S504, the controller 106 returns the process to Step S503.

For example, in the communication port use information 113 illustrated in FIG. 3, the use start date is not registered for the communication port 111 of SNMPD. In other words, the SNMPD communication port 111 is not in use and the total number of days used is 0. In the controller 106, the total number of days used of the image forming apparatus 100 is 220 days. It is assumed that Y days in Step S504 is 100 days, for example. In this case, the total number of days used (=220 days) of the image forming apparatus 100 is 100 days or more in Step S504, the controller 106 determines that the SNMPD communication port 111 is not in use. Then, the controller 106 shifts the process to Step S602 illustrated in FIG. 6, for the SNMPD communication port 111.

In a case where the determination target communication port 111 has been used in Step S503, the controller 106 determines whether or not a total frequency of use of the determination target communication port 111 is equal to or greater than V %, in Step S505. V % is a predetermined percentage. For example, the controller 106 calculates, a ratio of the total number of days used of the determination target communication port 111 recorded in the communication port use information 113 to the total number of days used of the image forming apparatus 100 recorded in the apparatus use information 112, as first total frequency of use. Furthermore, the controller 106 calculates a ratio of the total number of days used of the determination target communication port 111 recorded in the communication port use information 113 to the number of days elapsed since the use start date recorded in the communication port use information 113, as a second total frequency of use. The controller 106 determines higher one of the first total frequency of use and the second total frequency of use as the total frequency of use. Then, the controller 106 determines whether or not the determined total frequency of use is equal to or greater than V %.

In a case where the total frequency of use is equal to or greater than V % in Step S505, the controller 106 shifts the process to Step S601 illustrated in FIG. 6. On the other hand, in a case where the total frequency of use is less than V % in Step S505, the controller 106 determines whether or not the number of consecutive days of non-use of the determination target communication port 111 is W days or more, in Step S506. W days is a predetermined number of days. Specifically, the controller 106 determines whether or not the number of consecutive days of non-use linked to the determination target communication port 111 in the communication port use information 113 is W days or more.

In a case where the number of consecutive days of non-use of the determination target communication port 111 is less than W days in Step S506, the controller 106 determines that the determination target communication port 111 is in use. Then, the controller 106 returns the process to Step S505.

On the other hand, in a case where the number of consecutive days of non-use of the determination target communication port 111 is equal to or greater than W days in Step S506, the controller 106 determines that the determination target communication port 111 is not in use. Then, the controller 106 shifts the process to Step S602 illustrated in FIG. 6.

It is assumed that the HTTP communication port 111 is open, for example. Furthermore, for HTTP communication port 111, the use start date is Jan. 1, 2023, the total number of days used is 210 days, and the number of consecutive days of non-use is 2 days.

The controller 106 calculates the first total frequency of use of the HTTP communication port 111 as 95% (=210/220×100), which is the ratio of the total number of days used of the HTTP communication port 111, which is 210 days, to the total number of days used of the image forming apparatus 100 recorded in the apparatus use information 112, which is 220 days. In addition, the controller 106 calculates the second total frequency of use of the HTTP communication port 111 as 57% (=210/365×100), which is the ratio of the total number of days used of the HTTP communication port 111, which is 210 days, to the number of days elapsed from the use start date of Jan. 1, 2023 to Dec. 31, 2023, which is 365 days.

The controller 106 determines 95% which is the total frequency of use of the HTTP communication port 111, that is, higher one of the first total frequency of use (=95%) and the second total frequency of use (=57%), as the total frequency of use. For example, it is assumed that V % in Step S505 is 40%. In this case, the total frequency of use (=95%) of the HTTP communication port 111 is 40% or more in Step S505, and therefore the controller 106 shifts the process to Step S601 illustrated in FIG. 6.

It is assumed that the IPP communication port 111 is open, for example. Furthermore, for the IPP communication port 111, the use start date is Jan. 15, 2023, the total number of days used is 100 days, and the number of consecutive days of non-use is 1 day.

The controller 106 calculates the first total frequency of use of the IPP communication port 111 as 45% (=100/220×100), which is the ratio of the total number of days used of the IPP communication port 111, which is 100 days, to the total number of days used of the image forming apparatus 100 recorded in the apparatus use information 112, which is 220 days. In addition, the controller 106 calculates the second total frequency of use of the IPP communication port 111 as 28% (=100/350×100), which is the ratio of the total number of days used of the IPP communication port 111, which is 100 days, to the number of days elapsed from the use start date of Jan. 15, 2023 to Dec. 31, 2023, which is 350 days.

The controller 106 determines 45% which is the total frequency of use of the IPP communication port 111, that is, higher one of the first total frequency of use (=45%) and the second total frequency of use (=28%), as the total frequency of use. For example, it is assumed that V % in Step S505 is 40%. In this case, the total frequency of use (=45%) of the IPP communication port 111 is 40% or more in Step S505, and therefore the controller 106 shifts the process to Step S601 illustrated in FIG. 6.

It is assumed that the FTP communication port 111 is open, for example. For the FTP communication port 111, the use start date is Jan. 1, 2023, the total number of days used is 100 days, and the number of consecutive days of non-use is 200 days.

The controller 106 calculates the first total frequency of use of the FTP communication port 111 as 0.9% (=2/220×100), which is the ratio of the total number of days used of the FTP communication port 111, which is 2 days, to the total number of days used of the image forming apparatus 100 recorded in the apparatus use information 112, which is 220 days. In addition, the controller 106 calculates the second total frequency of use of the FTP communication port 111 as 0.5% (=2/365×100), which is the ratio of the total number of days used of the FTP communication port 111, which is 2 days, to the number of days elapsed from the use start date of Jan. 1, 2023 to Dec. 31, 2023, which is 365 days.

The controller 106 determines 0.9% which is the total frequency of use of the FTP communication port 111, that is, higher one of the first total frequency of use (=0.9%) and the second total frequency of use (=0.5%), as the total frequency of use. For example, it is assumed that V % in Step S505 is 40%. In this case, the total frequency of use (=0.9%) of the FTP communication port 111 is less than 40% in Step S505, and therefore the controller 106 shifts the process to Step S506 illustrated in FIG. 6.

It is assumed that W days in Step S506 is 90 days, for example. In this case, 100 days which is the number of consecutive days of non-use of the FTP communication port 111 is equal to or greater than 90 days in Step S506, and therefore the controller 106 determines that the FTP communication port 111 is not in use. Then, the controller 106 shifts the process for the FTP communication port 111 to Step S602 illustrated in FIG. 6.

It is assumed that the SMTP communication port 111 is open, for example. Furthermore, for the SMTP communication port 111, the use start date is Jan. 1, 2023, the total number of days used is 100 days, and the number of consecutive days of non-use is 100 days.

The controller 106 calculates the total frequency of use of SMTP communication port 111 as 45%, just like the IPP communication port 111. In a case where V % in Step S505 is 40%, the total frequency of use (=45%) of the SMTP communication port 111 is 40% or more in Step S505, and therefore the controller 106 shifts the process to Step S601 illustrated in FIG. 6.

It is assumed that the LDAP communication port 111 is open, for example. Furthermore, for the LDAP communication port 111, the use start date is Oct. 1, 2023, the total number of days used is 500 days, and the number of consecutive days of non-use is 1 days.

The controller 106 calculates the first total frequency of use of the LDAP communication port 111 as 22% (=50/220×100), which is the ratio of the total number of days used of the LDAP communication port 111, which is 50 days, to the total number of days used of the image forming apparatus 100 recorded in the apparatus use information 112, which is 220 days. In addition, the controller 106 calculates the second total frequency of use of the LDAP communication port 111 as 54% (=50/92×100), which is the ratio of the total number of days used of the LDAP communication port 111, which is 50 days, to the number of days elapsed from the use start date of Oct. 1, 2023 to Dec. 31, 2023, which is 92 days.

The controller 106 determines 54% which is the total frequency of use of the LDAP communication port 111, that is, higher one of the first total frequency of use (=22%) and the second total frequency of use (=54%), as the total frequency of use. For example, it is assumed that V % in Step S505 is 40%. In this case, the total frequency of use (=54%) of the LDAP communication port 111 is 40% or more in Step S505, and therefore the controller 106 shifts the process to Step S601 illustrated in FIG. 6.

FIG. 6 is a flowchart illustrating an example of operation of the image forming apparatus 100, which follows FIG. 5.

In a case where the total frequency of use is equal to or greater than V % in Step S505 illustrated in FIG. 5, the controller 106 determines whether or not the number of consecutive days of non-use of the determination target communication port 111 is equal to or less than W days, in Step S601. In a case where the number of consecutive days of non-use of the determination target communication port 111 exceeds W days in Step S601, the controller 106 determines that the determination target communication port 111 is not in use. Then, the controller 106 shifts the process to Step S602.

On the other hand, in a case where the number of consecutive days of non-use of the determination target communication port 111 is equal to or less than W days in Step S601, the controller 106 determines that the determination target communication port 111 is in use. Then, the controller 106 keeps the determination target communication port 111 open and ends the process for the determination target communication port 111. In this case, the controller 106 does not execute the process of reporting the target communication port information for the determination target communication port 111. Furthermore, the controller 106 does not execute any process of suggesting to the user to close the determination target communication port.

Therefore, in Step S601, or Step S506 illustrated in FIG. 5, in a case where the number of consecutive days of non-use of the determination target communication port 111 exceeds W days, the controller 106 shifts the process to Step S602. Then, the controller 106 shifts the process to Step S602 illustrated in FIG. 6. That is, in a case where the controller 106 determines that the determination target communication port 111 is not in use, the controller 106 shifts the process to Step S602 illustrated in FIG. 6.

It is assumed that W days in Step S601 is 90 days, for example. In this case, the controller 106 determines that the HTTP communication port 111 is in use because the number of consecutive days of non-use of the HTTP communication port 111, which is 2 days, is 90 days or less. In addition, the controller 106 determines that the IPP communication port 111 is in use because the number of consecutive days of non-use of the IPP communication port 111 which is 1 day is 90 days or less. Additionally, the controller 106 determines that the SMTP communication port 111 is not in use because the number of consecutive days of non-use of the SMTP communication port 111, which is 100 days, exceeds 90 days.

Furthermore, the controller 106 determines that the LDAP communication port 111 is in use because the number of consecutive days of non-use of the LDAP communication port 111, which is 1 day, is 90 or less.

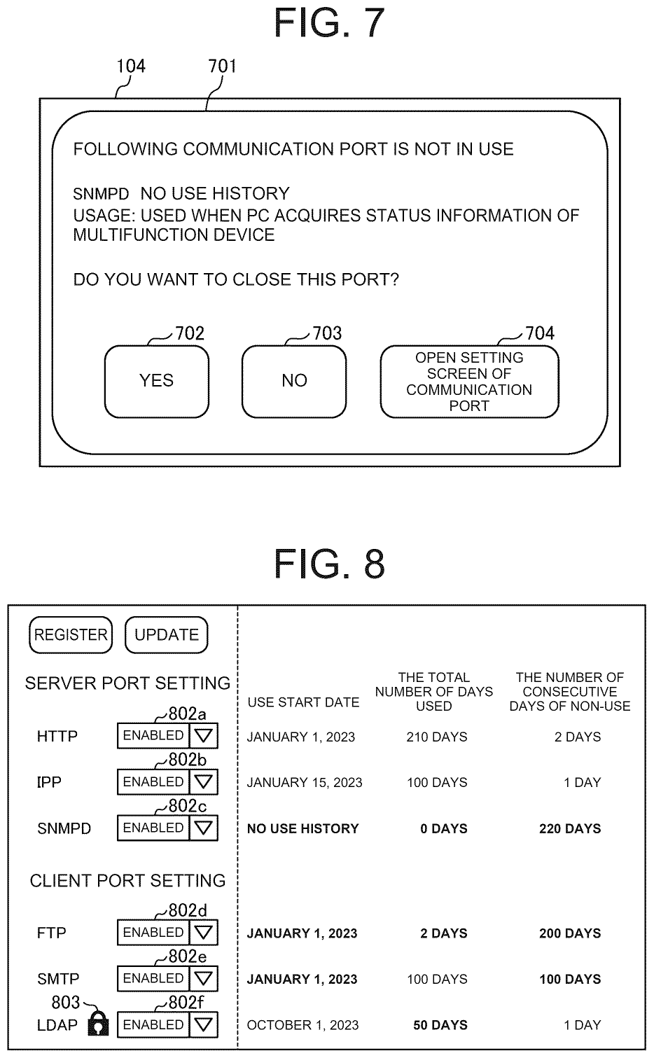

In Step S602, the controller 106 displays a report screen 701 (see FIG. 7) on the display 104. The report screen 701 indicates target communication port information for the determination target communication port. Furthermore, the report screen 701 includes a message suggesting a user to close the determination target communication port.

For example, when the image forming apparatus 100 is started, the controller 106 executes the processes of Step S501 to Step S506 illustrated in FIG. 5 and Step S601 to Step S602 illustrated in FIG. 6. That is, the controller 106 executes a process of reporting the target communication port information when the image forming apparatus is started.

Alternatively, the controller 106 authenticates a user who uses the image forming apparatus 100, and in a case where the user is authenticated as a user who has a specified authority, the controller 106 executes the processes of Step S501 to Step S506 illustrated in FIG. 5 and Step S601 to Step S602 illustrated in FIG. 6. That is, the controller 106 may execute a process of reporting the target communication port information when the image forming apparatus 100 is used by the user who has the specified authority. For example, the specified authority is an authority of an administrator of the image forming apparatus 100.

In Step S603, the controller 106 determines whether or not the operation acceptor 103 accepts operation of closing the determination target communication port 111. In a case where the operation acceptor 103 does not accept the operation of closing the determination target communication port in Step S603, the controller 106 keeps the determination target communication port 111 in an open state, and the controller 106 ends the process for the determination target communication port 111.

On the other hand, in a case where the operation acceptor 103 accepts the operation of closing the determination target communication port in Step S603, the controller 106 executes a process of closing the determination target communication port 111 so as to disable communication through the determination target communication port 111 in Step S604. Then, the controller 106 ends the process for the determination target communication port 111.

For example, in a case where an unused server port is open, there is a risk that a malicious user may access the image forming apparatus 100 from outside through this server port. In addition, for example, in a case where an unused client port is open, there is a risk that a malicious user may access an inappropriate destination via this client port. However, the image forming apparatus 100 according to this embodiment can close the unused communication port 111 so as to disable communication by executing the processes of Step S602 to Step S604, by user operation. Consequently, the image forming apparatus 100 according to this embodiment can prevent the unused communication port 111 from being left open. As a result, the image forming apparatus 100 according to this embodiment can suppress the risk of unauthorized access by the malicious user.

FIG. 7 illustrates an example of the report screen 701. The report screen 701 includes a message suggesting that the target communication port that is open and not in use be closed. For example, the report screen 701 illustrated in FIG. 7 includes a message suggesting a user that the SNMPD communication port 111 be closed. Furthermore, the target communication port information indicated on the report screen 701 includes information indicating usage for a target communication port that is open and not in use. For example, the report screen 701 illustrated in FIG. 7 indicates information indicating usage of the SNMPD.

As illustrated in FIG. 7, the controller 106 indicates the target communication port that is open and not in use, so that a user can determine whether or not the communication port 111 indicated on the report screen 701 is closed even in a case where the user does not have knowledge of the type of the communication port 111.

In a case where the operation acceptor 103 accepts the operation of selecting a “Yes” button 702, the controller 106 executes a process of closing the communication port 111 indicated on the report screen 701, in Step S604 illustrated in FIG. 6. For example, in a case where the operation acceptor 103 accepts operation of selecting the “Yes” button 702 on the report screen 701 illustrated in FIG. 7, the controller 106 executes the process of closing the SNMPD communication port 111 in Step S604. Consequently, communication through the SNMPD communication port 111 is disabled.

In a case where the operation acceptor 103 accepts operation of selecting a “No” button 703 is selected, the controller 106 keeps the determination target communication port 111 open and ends the process for the determination target communication port 111. For example, in the report screen 701 illustrated in FIG. 7, in a case where the operation acceptor 103 accepts the operation of selecting the “No” button 703, the controller 106 keeps the SNMPD communication port 111 open and ends the process for the SNMPD communication port 111.

In a case where the operation acceptor 103 accepts operation of selecting an “open a communication port setting screen” button 704, the controller 106 executes a process of displaying a setting screen 801 (see FIG. 8) on the display 104.

FIG. 8 is a diagram illustrating an example of the setting screen 801. The setting screen 801 includes open/close setting fields 802a to 802f for the plurality of respective communication ports 111.

The types of the plurality of communication ports 111 indicated in the setting screen 801 illustrated in FIG. 8 are an HTTP, an IPP, an SNMPD, an FTP, an SMTP, and an LDAP. The use start date, the total number of days used, and the number of consecutive days of non-use illustrated in FIG. 8 are the same as the use start date, the total number of days used, and the number of consecutive days of non-use, which are registered in the communication port use information 113 illustrated in FIG. 3. Therefore, the controller 106 determines that the HTTP communication port 111, the IPP communication port 111, and the LDAP communication port 111 are in use. On the other hand, the controller 106 determines that the SNMPD communication port 111, the FTP communication port 111, and the SMTP communication port 111 are not in use.

The open/close setting field 802a to the open/close setting field 802f indicate open/close information for the HTTP, IPP, SNMPD, FTP, SMTP, and LDAP communication ports 111, respectively. The open/close setting field 802a to the open/close setting field 802f accept user operation, so that the controller 106 sets the open/close state according to the user operation.

For example, the open/close setting field 802a to the open/close setting field 802f indicate “enabled,” and therefore the open/close information indicated by the open/close setting field 802a to the open/close setting field 802f indicates that the respective communication ports 111 are available for communication and is open. That is, the setting screen 801 illustrated in FIG. 8 indicates that the plurality of communication ports 111, which are the HTTP, IPP, SNMPD, FTP, SMTP, and LDAP communication ports, are open.

The controller 106 highlights and displays an item that is determined not to be in use among the use start date, the total number of days used, and the number of consecutive days of non-use of the target communication port 111 that is open and not in use. For example, for the SNMPD communication port 111 and the FTP communication port 111, the use start date, the total number of days used, and the number of consecutive days of non-use are highlighted and displayed. In addition, the use start date and the number of consecutive days of non-use of the SMTP communication port are highlighted and displayed.

In a case where the operation acceptor 103 accepts operation for the open/close setting field 802a to the open/close setting field 802f, the controller 106 executes a process of opening or closing the communication port 111.

For example, in a case where the operation acceptor 103 accepts operation of changing the open/close setting field 802c from “enabled” to “disabled,” the controller 106 executes a setting process of closing the SNMPD communication port 111. Consequently, the image forming apparatus 100 can allow the user to close the communication port 111 in accordance with an actual usage situation. Furthermore, the image forming apparatus 100 allows the user to perform operation of closing the communication port 111, so that it is possible to prevent the user from accidentally closing the communication port 111 that should not be closed.

Furthermore, the controller 106 may be able to set the communication port 111 such that the communication port 111 cannot be closed. For example, in a case where the operation acceptor 103 accepts operation of setting the communication port 111 such that the communication port 111 cannot be closed, the controller 106 sets the communication port 111 such that the communication port 111 cannot be closed. Consequently, it is possible to allow the image forming apparatus 100 not to give the user the authority of closing the communication port 111.

Furthermore, in a case where the communication port 111 is set to be unable to be closed, the controller 106 displays an image 803 indicating that the communication port 111 cannot be closed. Consequently, the image forming apparatus 100 can allow the user to recognize that the communication port 111 cannot be closed.

As described above, the image forming apparatus 100 according to this embodiment presents the unused communication port 111 to the user and prompts the user to perform the setting operation of closing this communication port 111. Consequently, the image forming apparatus 100 according to this embodiment can open the communication ports 111 necessary for the user such that this communication ports can communicate, while preventing the unused communication port 111 from being left open, and therefore it is possible to suppress the risk of unauthorized access by a malicious user.

### First Modification

As a first modification of the image forming apparatus 100 according to this embodiment, an image forming apparatus 100 may allow a user to select to close a communication port 111 for a limited predetermined period.

In a controller 106 according to this modification, after an unused target communication port 111 is closed, in a case where an operation acceptor 103 receives confirmation operation of confirming a state in which a target communication port 111 is closed, the controller 106 confirms the state in which the target communication port is closed. On the other hand, after the unused target communication port 111 is closed, in a case where the operation acceptor 103 does not accept the confirmation operation, a process of opening the target communication port 111 is executed.

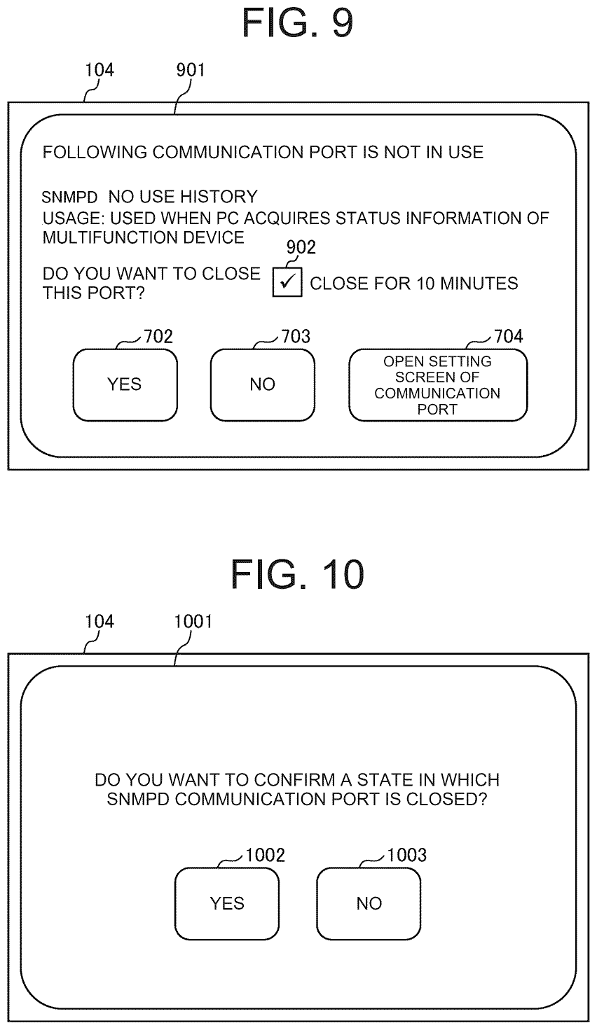

FIG. 9 is a diagram illustrating an example of a report screen 901 according to a first modification. A difference between the report screen 901 and the report screen 701 illustrated in FIG. 7 is that the report screen 901 includes a checkbox 902.

In a case where the operation acceptor 103 accepts operation of selecting the checkbox 902 and also accepts operation of selecting a “Yes” button 702, the controller 106 executes a process of closing a communication port 111 indicated on the report screen 901, and the controller 106 causes a display 104 to display a confirmation screen 1001 (see FIG. 10). For example, in the example of the report screen 901 illustrated in FIG. 9, a confirmation screen 1001 is displayed on the display 104 for a maximum of 10 minutes.

FIG. 10 is a diagram illustrating an example of the confirmation screen 1001. The confirmation screen 1001 includes a message that allows the user to select whether or not to a state in which the communication port 111 indicated on the report screen 901 is closed is released. For example, in a case where the communication port 111 illustrated in FIG. 9 is the SNMPD communication port 111, the confirmation screen 1001 includes a message “Do you want to confirm a state in which the SNMPD communication port is closed?” Furthermore, the confirmation screen 1001 includes a “Yes” button 1002 and a “No” button 1003.

In a case where the operation acceptor 103 accepts the operation of selecting the “Yes” button 1002, the controller 106 confirms to close the communication port 111 indicated on the report screen 901 illustrated in FIG. 9. For example, after the display 104 displays the report screen 901 illustrated in FIG. 9, in a case where the operation acceptor 103 accepts the operation of selecting the “Yes” button 1002, the controller 106 confirms to close the SNMPD communication port 111. Then, the controller 106 hides the confirmation screen 1001.

On the other hand, in a case where the operation acceptor 103 accepts operation of selecting the “No” button 1003, the controller 106 releases the communication port 111 indicated on the report screen 901 illustrated in FIG. 9 from the closed state. In other words, in a case where the operation acceptor 103 accepts the operation of selecting the “No” button 1003, the controller 106 opens the communication port 111 indicated in the report screen 901 illustrated in FIG. 9 such that communication is possible. Then, the controllers 106 hides the confirmation screen 1001.

Also, in a case where the operation acceptor 103 does not accept the operation of selecting the “Yes” button 1002 and the “No” button 1003 for the predetermined period, the state in which the communication port 111 indicated in the report screen 901 illustrated in FIG. 9 is closed is released. For example, when the display 104 displays the confirmation screen 1001 illustrated in FIG. 10, in a case where the operation acceptor 103 does not accept the operation of selecting the “Yes” button 1002 and the “No” button 1003 for 10 minutes, the controller 106 releases the closed state of the SNMPD communication port 111. In other words, in a case where the operation acceptor 103 does not accept the operation of selecting the “Yes” button 1002 and the “No” button 1003, the controller 106 opens the communication port 111 indicated in the report screen 901 illustrated in FIG. 9 such that communication is possible. Then, the controller 106 hides the confirmation screen 1001.

As described above, the image forming apparatus 100 according to this modification enables the user to select the communication port 111 and then to select to release the communication port 111 from the closed state. Consequently, the image forming apparatus 100 according to this modification enables the user to select to release the closed state of the communication port 111 even in a case where an inconvenience occurs with the communication port 111 closed.

### Second Modification

As a second modification of the image forming apparatus 100 according to this embodiment, an image forming apparatus 100 may notify an administrator of the image forming apparatus 100 of an access status to a closed communication port 111. Specifically, the controller 106 according to this modification executes a process of reporting the access status to the unused communication port after the communication port is closed.

For example, in a case where an attempt is made to receive a signal on a closed communication port 111, or in a case where an attempt is made to transmit a signal from the closed communication port 111, the controller 106 executes a process of notifying the administrator of the image forming apparatus 100 of a message indicating that communication has been attempted on the closed communication port 111. For example, the controller 106 may transmit, to a terminal of the administrator of the image forming apparatus 100, a message reporting that communication has been attempted on the closed communication port 111. Alternatively, the controller 106 may notify the administrator of the image forming apparatus 100 by e-mail that communication has been attempted on the closed communication port 111.

In the case where an attempt is made to receive a signal on the closed communication port 111, or in the case where an attempt is made to transmit a signal from the closed communication port 111, this communication port 111 may not be one that should be closed. Therefore, the image forming apparatus 100 according to this modification can allow the administrator of the image forming apparatus 100 to reconsider whether or not to open the communication port 111 to enable communication, by a message indicating that communication has been attempted on the closed communication port 111.

In addition, in the case where an attempt is made to receive a signal on the closed communication port 111, or in the case where an attempt is made to transmit a signal from the closed communication port 111, unauthorized access by a malicious user may have been conducted. Therefore, the image forming apparatus 100 according to this modification can prompt the administrator of the image forming apparatus 100 to analyze an access content by the message indicating that communication has been attempted on the closed communication port 111.

On the other hand, in a case where there is no attempt to receive a signal on the closed communication port 111 and no attempt to transmit a signal from the closed communication port 111, the controller 106 does not execute a process of reporting the access status to the closed communication port 111. Consequently, the image forming apparatus 100 can allow the administrator of the image forming apparatus 100 to recognize that closing the communication port 111 is correct.

As described above, the image forming apparatus 100 according to this modification can monitor the access status to the communication port 111 that is closed among the plurality of communication ports 111, and can allow the administrator of the image forming apparatus 100 to be aware of the access status to the communication port 111.

### Third Modification

As a third modification of the image forming apparatus 100 according to this embodiment, an image forming apparatus 100 according to this modification may notify an administrator or the like in a case where a communication port 111 which belongs to a preselected type is open and is not in use. Specifically, a controller 106 according to this modification may execute a process of notifying a user having a specified authority of target communication port information in a case where an unused target communication port 111 is a communication port 111 which belongs to a preselected type. For example, the communication port 111 which belongs to the preselected type is a communication port that is determined to be important by the user.

As described above, in a case where the communication port which is important is open and not in use, the image forming apparatus 100 according to this modification can notify only the administrator of information indicating the important communication port 111.

The respective processes executed in the above embodiments are not limited to the process modes exemplified in each embodiment. The above functional blocks may be realized using either logic circuits (hardware) formed on an integrated circuit or software using a CPU. Each process executed in the above embodiments may be executed by a plurality of computers. For example, the processes executed by the controllers 106 may be partially executed by another computer, or all of the processes may be shared and executed by a plurality of computers.

The present disclosure is not limited to the above-described embodiments, and may be replaced with a configuration that is substantially the same as the configuration indicated in the above-described embodiments, a configuration that has the same function and effect, or a configuration that can achieve the same object. The present disclosure also includes within the technical scope embodiments obtained by appropriately combining the technical means disclosed in the different embodiments. Furthermore, a new technical feature can be formed by combining the technical means disclosed in each embodiment.

What is claimed is:

1. An image forming apparatus comprising:
a communicator having a plurality of communication ports; and
at least one controller that executes a process of determining whether or not each of the communication ports is a target communication port that is open and not in use from an open/closed state and a use history of each communication port included in the plurality of communication ports, and reporting target communication port information indicating the target communication port.

2. The image forming apparatus according to claim 1, wherein
the controller sets whether or not each of the communication ports is opened or closed.

3. The image forming apparatus according to claim 1, wherein
the controller executes a process of prompting a user to close the target communication port.

4. The image forming apparatus according to claim 1, wherein
the use history includes and indicates information indicating a use start date, the total number of days used, and the number of consecutive days of non-use of each of the communication ports, and
the controller determines whether or not each of the communication ports is not in use from the use start date, the total number of days used, and the number of consecutive days of non-use of each of the communication ports.

5. The image forming apparatus according to claim 4,
further comprising a display, wherein
the controller displays the use history on the display, and highlights and displays an item that is determined not to be in use among the use start date, the total number of days used, and the number of consecutive days of non-use of the target communication port, on the display.

6. The image forming apparatus according to claim 1, wherein
the target communication port information includes information indicating usage for the target communication port.

7. The image forming apparatus according to claim 1, wherein
the controller executes a process of reporting the target communication port information when the image forming apparatus is started.

8. The image forming apparatus according to claim 1, wherein
the controller executes a process of reporting the target communication port information when the image forming apparatus is used by a user who has a specified authority.

9. The image forming apparatus according to claim 8, wherein
the controller executes a process of notifying the user having the authority of the target communication port information in a case where the target communication port is a communication port which belongs to a preselected type.

10. The image forming apparatus according to claim 1, wherein
further comprising an operation acceptor,
after the target communication port is closed, in a case where the operation acceptor receives confirmation operation of confirming a state in which the target communication port is closed, the controller confirms the state in which the target communication port is closed, and in a case where the operation acceptor does not accept the confirmation operation, the controller executes a process of opening the target communication port.

11. The image forming apparatus according to claim 1, wherein
the controller executes a process of reporting an access status to the target communication port after the target communication port is closed.
